(19) United States
(12) Patent Application Publication
(10) Pub. No.: US 2005/0058791 A1
(43) Pub. Date: Mar. 17, 2005

(54) Packaging films and methods for producing the same

(75) Inventors: Andrew W. Moehlenbrock, Simpsonville, SC (US); Gautam Shah, Simpsonville, SC (US); Wendy Dunlap, Duncan, SC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Cryovac, Inc.

(21) Appl. No.: 10/661,848

(22) Filed: Sep. 12, 2003

(51) Int. Cl. B32B 3/10; F16L 1/00

(52) U.S. Cl. 428/35.7; 428/138

(57) ABSTRACT

A multilayer film is provided that includes at least one microporous layer formed from an oxygen impermeable composition disposed between outer layers formed from at least one heat sealable composition. The multilayer film is preferably a coextruded film. The film is especially suitable for packaging oxygen-sensitive products.

### FIELD OF THE INVENTION

The present invention relates to multi-layer films, particularly multi-layer films suitable for use as packaging films. The present invention is also directed to processes of making multi-layer films, packaging processes, and packaged products. The present invention is particularly related to films suitable for packaging oxygen-sensitive products.

### BACKGROUND OF THE INVENTION

Food packaging films must provide a suitable balance of a number of physical properties, including adequate tensile strength, appropriate gas headspace compositions within the packaging, and acceptable aesthetics, i.e., suitable transparency and smooth surface.

The requirements for food packaging films are particularly rigorous because many types of foodstuffs, such as raw vegetables, fruits, meats and cheeses, are oxygen sensitive. These products exhibit lower shelf life in the presence of too much oxygen or too little oxygen within the package. The gas transport properties, particularly the oxygen transmission rate (“OTR”), carbon dioxide transmission rate (“CO₂TR”) and moisture vapor transmission rate (“MVTR”), of films used in conjunction with these foods is thus especially important.

Fresh produce is particularly challenging to package due to the fact that it continues to respire after harvesting and processing. Respiration is the process by which produce items consume oxygen and produce carbon dioxide, heat and water. To further complicate matters, different produce items have different respiration rates (“RRs”), and RRs are affected by storage temperature, growing conditions, and injury (degree of processing). Whole onions, for example, have a RR of 3-4 mg carbon dioxide produced/kg hr at 3-4° C., while whole broccoli has a much higher RR of 32-37 mg/kg hr at the same temperature. Whole carrots (from muck soil) have a RR of 9 mg/kg hr at 10° C., while grated carrots have a RR of 20-25 mg/kg hr at the same temperature.

When packaging fresh produce, the presence of too much oxygen within the headspace of the package generally leads to oxidation and aerobic bacterial growth. Conversely, too little oxygen within the packaging headspace induces anaerobiosis within the foodstuffs, causing spoilage and fermentation. The desired amount of oxygen within the packaging headspace is further not generally the amount present within the ambient air. For example, some publications suggest that the total headspace for broccoli should contain about 1 to 2% oxygen. In contrast, the ambient air contains significantly greater amounts of oxygen, i.e. about 23%.

The headspace gas composition within produce packaging represents a delicate balance between the gas transmission properties of the packaging film and the foodstuff RR. Therefore, the OTR, CO₂TR, and MVTR of the packaging material must be matched to the RR of the produce item in order to extend the shelf life of the product. Generally, produce items with higher respiration rates, such as broccoli, cauliflower, spinach and corn, are more difficult to package successfully due to the lack of packaging materials available with the desired OTR, CO₂TR, and MVTR.

Perforated produce films providing an acceptable balance of tensile properties, OTR, CO₂TR, MVTR and optics are commercially available. Perforated produce films, including laminated, coextruded and monolayer constructions, are initially formed as non-porous continuous films. These continuous films are then subjected to a separate perforation process that imparts a plurality of holes throughout the entire thickness of the film. Unfortunately, perforated films allow the produce to dry out over time, especially when the packaged food is stored in a dry environment. The through-hole configuration of conventional produce films also allows the produce to become contaminated, such as by airborne dust and the like. The perforations must be placed in specific areas within the packaging; therefore a separate perforation step is required. Perforated films are thus more expensive to manufacture due to the separate perforation step.

Resins providing elevated OTR rates are known. For example, high oxygen transmission rate films have been produced from 4-methyl pentane resins. However, 4-methyl pentane is expensive. High oxygen transmission rate films with superior tensile properties are also provided in U.S. Pat. Nos. 5,491,019 and 5,962,092 to Kuo et al., hereby incorporated by reference in their entirety. Kuo's films have been used extensively in foodstuff packaging, particularly for lettuce and the like, but there remains room for improvement in the art.

Gas transmission rates for vegetable packaging films may also be tailored to a desired level by varying the overall thickness of a continuous multilayer film. For example, continuous multilayer films formed from more conventional resins are known for use as produce packaging films. Higher oxygen transmission rates are provided in such films by decreasing the film thickness. Such downgauging is often done at the expense of machinability and abuse resistance.

The equipment used to package foodstuffs generally requires packaging films exhibiting sufficient machinability. Foodstuffs, particularly fresh produce, are frequently packaged using vertical form fill and seal (VFFS) equipment. In VFFS, foodstuffs are introduced through a central, vertical fill tube into a formed tubular film that has been heat-sealed both vertically and transversely at its lower end. After being filled, the package, in the form of a pouch, is completed by transversely heat-sealing the upper end of the tubular segment, and severing the pouch from the tubular film above it. Consequently, multilayer films used in VFFS equipment must have surface layers sealable with the hot bar or impulse type sealing systems employed in such equipment. The multilayer film must further exhibit sufficient stiffness and dimensional stability to survive both the sealing process and the web advancement process within the VFFS machine. Packaging films having poor properties may suffer burn-through during sealing, while films having insufficient dimensional stability may become distorted during sealing, e.g., may pucker at the seal.

Unfortunately, films having acceptable stiffness and dimensional stability typically have lower gas transmission properties. It is therefore desirable to provide continuous films combining acceptable physical properties with beneficial gas transmission properties.

### BRIEF SUMMARY OF THE INVENTION

The present invention provides a more economically produced multilayered film exhibiting a beneficial balance of gas transport properties and mechanical properties. The multilayer films of the invention generally include a first outer layer, a second outer layer and at least one intermediate microporous layer disposed between the first and second outer layers. The first and second outer layers are each formed from the same or different heat sealable compositions. The intermediate layer is formed from an oxygen impermeable composition, preferably an unfilled oxygen impermeable composition. Advantageously, the oxygen impermeable composition further includes polypropylene homopolymer or propylene-alpha olefin copolymer as the primary polymer.

In alternative advantageous embodiments, the present invention provides multilayer films that include a first outer layer, a second outer layer, a center layer, a first intermediate microporous layer disposed between the first outer layer and the center layer, and a second intermediate microporous layer disposed between the second outer layer and the center layer. The first and second outer layers and center layer are each formed from either the same or different heat sealable compositions. The first and second intermediate layers are each formed from either the same or different oxygen impermeable compositions. The oxygen impermeable composition advantageously exhibits a higher melting point and/or a higher modulus than the heat sealable composition.

Advantageously, the oxygen impermeable composition is formed from at least one of polyethylene homopolymer, polypropylene homopolymer, ethylene/alpha-olefin copolymer, propylene/ethylene copolymer, ethylene/unsaturated ester copolymer, styrene homopolymer, styrene copolymer or polyester. In preferred embodiments of the invention, the oxygen impermeable composition is formed from a polypropylene/ethylene copolymer, particularly a polypropylene/ethylene copolymer that includes from about 0.1 to 6 weight percent mer units derived from ethylene.

The heat sealable composition is advantageously formed from either an ethylene/alpha olefin copolymer, particularly linear low density polyethylene, or a homogeneous polyethylene. In beneficial embodiments of the invention, at least one of the first and second outer layers further comprises an effective amount of at least one antiblock agent. In further beneficial aspects, at least one of the first and second outer layers further comprises an effective amount of at least one slip agent.

The multilayer films of the invention generally range in thickness from about 1 mil to 10 mil, such as from about 1.5 to 3 mil. In particularly advantageous embodiments, each of the first and second outer layers independently account for from about 10 to 80 volume percent of the multilayer film, each of the intermediate microporous layers independently accounts for from about 10 to 80 volume percent of said multilayer film, and the center layer accounts for from about 10 to 60 volume percent of said film.

The multilayer film typically exhibits an oxygen transmission rate of from about 160 to 1290 cc/100 in²-24 hr-atm @ standard temperature (“std. temp.”), such as from about 250 to 650 cc/100 in²-24 hr-atm @ std. temp. As used herein, “standard temperature” is 73° F.

The present invention further includes methods of producing the beneficial multilayer films. The present invention also includes packaged food incorporating the present multilayer films.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an enlarged cross-sectional view of one embodiment of a three-layer multilayer film of the present invention;

FIG. 2 illustrates an enlarged cross-sectional view of one embodiment of a five-layer multilayer film according to the present invention;

FIG. 3 illustrates an enlarged cross-sectional view of an alternative embodiment of a five-layer multilayer film according to the present invention;

FIG. 4 illustrates a schematic view of a process according to the present invention;

FIG. 5 illustrates a vertical form fill and seal apparatus to be used in packaging process according to the present invention; and

FIG. 6 illustrates a packaged product of the present invention, the product being packaged in the multilayer film of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, the term “monomer” refers to a relatively simple compound, usually containing carbon and of low molecular weight, which can react to form a polymer by combination with itself or with other similar molecules or compounds.

As used herein, the term “comonomer” refers to a monomer which is copolymerized with at least one different monomer in a copolymerization reaction, the result of which is a copolymer.

As used herein, the term “polymer” refers to the product of a polymerization reaction, and is inclusive of homopolymers, copolymers, terpolymers, etc.

As used herein, the term “homopolymer” is used with reference to a polymer resulting from the polymerization of a single monomer, i.e., a polymer consisting essentially of a single type of repeating unit.

As used herein, the term “copolymer” refers to polymers formed by the polymerization reaction of at least two different monomers. For example, the term “copolymer” includes the copolymerization reaction product of propylene and an alpha-olefin, such as ethylene. However, the term “copolymer” is also inclusive of, for example, the copolymerization of a mixture of ethylene, propylene, 1-hexene, and 1-octene.

As used herein, the term “copolymerization” refers to the simultaneous polymerization of two or more monomers.

As used herein, a copolymer identified in terms of a plurality of monomers, e.g., “propylene/ethylene copolymer”, refers to a copolymer in which the first listed monomer copolymerizes in a higher weight percent than the second listed monomer, and, for copolymers which are terpolymers, the first monomer copolymerizes in a higher weight percent than the second monomer, and the second monomer copolymerizes in a higher weight percent than the third monomer, etc.

As used herein, terminology employing a “/” with respect to the chemical identity of a copolymer (e.g., “a propylene/alpha-olefin copolymer”), identifies the comonomers which are copolymerized to produce the copolymer. This terminology, as used herein, refers to the primary comonomer first, followed by the secondary comonomer. The copolymerization is carried out in the presence of more (on a weight percent basis) of the primary comonomer than the secondary comonomer.

As used herein, the phrase “homogeneous polymer” refers to polymerization reaction products of relatively narrow molecular weight distribution and relatively narrow composition distribution. Homogeneous polymers are useful in various layers of the multilayer film used in the present invention. Homogeneous polymers exhibit a relatively even sequencing of comonomers within a chain, the mirroring of sequence distribution in all chains, and the similarity of length of all chains, and are typically prepared using metallocene, or other single-site type catalyst.

A homogeneous propylene/alpha-olefin copolymer can, in general, be prepared by the copolymerization of propylene and any one or more alpha-olefin. Preferably, the alpha-olefin is a C₂-C₂₀ alpha-monoolefin, more preferably, a C₂-C₁₂ alpha-monoolefin, still more preferably, a C₂ alpha-monoolefin. Still more preferably, the alpha-olefin comprises at least one member selected from the group consisting of ethylene, butene-1, hexene-1, and octene-1.

As used herein, the term “polyolefin” refers to any polymerized olefin, which can be linear, branched, cyclic, aliphatic, aromatic, substituted, or unsubstituted.

As used herein, the phrases “inner layer,” “internal layer” and “intermediate layer” refer to any film layer having two of its principal surfaces in contact with other layers of the multilayer film.

As used herein, the phrase “outer layer” refers to any film layer having only one of its principal surfaces directly adhered to another layer of the multilayer film.

As used herein, the phrase “directly adhered”, as applied to film layers, is defined as adhesion of the subject film layer to the object film layer, without a tie layer, adhesive, or other layer there between. In contrast, as used herein, the word “between”, as applied to a film layer, generally expressed as a given layer being “disposed between” two other specified layers, includes both direct adherence of the subject layer to the two other layers, as well as indirect adherence to either or both of the two other layers the subject layer is between, e.g., one or more additional tie layers can be imposed between the subject layer and one or more of the layers the subject layer is between.

As used herein, the term “core”, and the phrase “core layer”, as applied to multilayer films, refers to the centermost layer(s) within the laminate structure.

As used herein, the phrase “sealant layer”, with respect to multilayer films, refers to an outer film layer involved in the sealing of the film to itself or another layer. Although the phrase “sealant layer” as herein used refers only to outer layers, no matter how thin, it should also be recognized that in general, the outermost portion of a film is involved in the sealing of the film to itself or another layer.

As used herein, the phrase “tie layer” refers to any internal layer having the primary purpose of adhering two layers to one another.

As used herein, the term “lamination”, and the phrase “laminated film”, refer to the process, and resulting product, made by bonding together two or more layers of film or other materials. Lamination can be accomplished by joining layers with adhesives, joining with heat and pressure, and even spread coating and extrusion coating. Multilayer films can be made via coextrusion and/or lamination.

As used herein, the term “coextrusion” refers to the process of extruding two or more materials through a single die with two or more orifices arranged so that the extrudates merge and weld together into a laminar structure before chilling, i.e., quenching. Coextrusion can be employed in film blowing, free film extrusion, and extrusion coating processes.

As used herein, the phrase “machine direction”, herein abbreviated “MD”, refers to as a direction “along the length” of the film, i.e., in the direction of the film as the film is formed during extrusion and/or coating.

As used herein, the phrase “transverse direction”, herein abbreviated “TD”, refers to a direction across the film, perpendicular to the machine or longitudinal direction.

As used herein, “O₂-transmission rate”, also referred to as “OTR” and “oxygen permeability”, may be measured according to ASTM D 3985, a test known to those of skill in the film art.

As used herein, the “melt index” of a polymer is the amount, in grams, of a thermoplastic resin which can be forced through an orifice of 0.0825 inch diameter when subjected to a force of 2160 grams in ten minutes at a specified temperature, e.g., 190° C. for many polymers. The test is performed by an extrusion rheometer described in ASTM D 1238.

As used herein, the term “composition” generally refers to formulations that include one or more chemical materials.

As used herein, the term “modulus” generally refers to Young's modulus unless otherwise noted.

As used herein, the term “nonporous” refers to compositions and/or films that are generally continuous in nature and do not contain a significant number of pores, e.g. minute orifices.

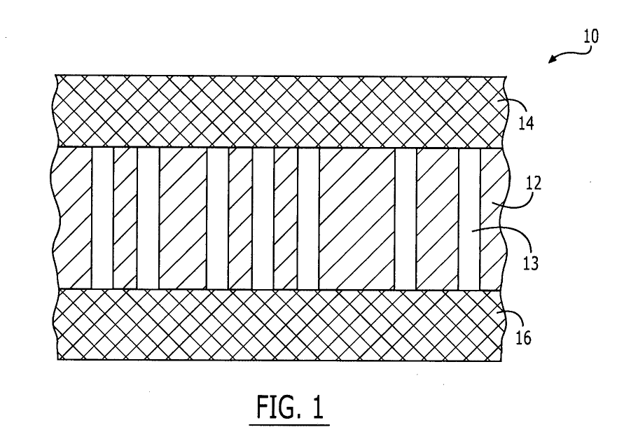

FIG. 1 illustrates a cross-sectional view of one advantageous embodiment of a multilayer film 10 in accordance with the invention. As shown in FIG. 1, the multilayer film 10 comprises at least one intermediate microporous layer 12 disposed between a first outer layer 14 and a second outer layer 16. Although the multilayered films of the invention are referred to as containing “layers,” this term is merely used to facilitate discussion concerning the differing compositions which may be present in various regions within the multilayer film 10. Such “layers” nevertheless provide unitary structures exhibiting cohesive properties throughout their thickness.

The microporous layer 12 is formed from an oxygen impermeable composition. As used herein, the term “oxygen impermeable composition” refers to a composition having an oxygen permeability that is either the same or lower than the heat sealable composition when both compositions are formed into comparable articles, such as comparable nonporous films. The oxygen impermeable composition typically exhibits an oxygen permeability that is at least about 50 cc-mil/100 in²-24 hr.-atm at std. temp lower than the heat sealable composition used to form the outer layers 14, 16, such as an oxygen permeability that is at least about 100 cc-mil/100 in²-24 hr.-atm at std. temp lower than the heat sealable polymer composition. Typically, the oxygen impermeable composition has an oxygen permeability of less than about 525 cc-mil/100 in²-24 hr.-atm at std. temp.

In particularly advantageous embodiments the oxygen impermeable composition is also a higher modulus polymer composition. As used herein, the term “higher modulus polymer composition” means a polymer composition having a greater modulus than the heat sealable composition used to form the outer layers 14, 16, such as a modulus at least about 5,000 psi higher than the modulus of the heat sealable composition. In advantageous embodiments of the invention, the higher modulus polymer compositions may generally be characterized by a modulus ranging from about 25,000 to 700,000 psi, such as a modulus ranging from about 100,000 to 400,000 psi.

Preferably, the oxygen impermeable composition also exhibits a higher melting temperature than the heat sealable composition. For example, the oxygen impermeable composition may have a melting point that is at least about 5° C. higher than the melting point of the heat sealable composition. In advantageous embodiments, the oxygen impermeable composition exhibits a melting point that is at least about 10° C. higher than the heat sealable composition.

Oxygen impermeable compositions may be formed from non-limiting exemplary primary polymers such as polyolefin polymers and copolymers, particularly polyethylene homopolymer, polypropylene homopolymer, ethylene/alpha-olefin copolymer, propylene/alpha-olefin copolymer and ethylene/unsaturated ester copolymer; styrene homopolymer, styrene copolymer; polyester polymers or copolymers and mixtures thereof. As used herein, the term “primary polymer” refers to the one or more polymers which form the bulk, e.g. the greatest amount, of a given polymer composition.

Suitable polyethylenes include higher modulus polyethylenes, such as medium density polyethylene, high density polyethylene and copolymers thereof. Suitable polypropylenes include homogenous polypropylene, heterogeneous polypropylene and copolymers and terpolymers thereof. Suitable propylene/alpha-olefin copolymers include propylene/ethylene copolymers. Non-limiting exemplary polyesters include polyethylene terephthalate and the like.

In advantageous embodiments, the oxygen impermeable composition is formed from either polypropylene homopolymer or a propylene/ethylene copolymer, particularly a propylene/ethylene random copolymer. In beneficial aspects of such embodiments, the propylene/ethylene copolymer contains from about 0.1 to 6 weight percent ethylene, such as from about 2 to 5 weight percent ethylene, particularly about 4 weight percent ethylene. ESCORENE® PD4062.E7 from Exxon Corp. of Houston, Tex. is an exemplary commercially available polypropylene homopolymer. 6D65L is a propylene/ethylene copolymer commercially available from Dow Chemical Company of Midlands, Mich.

As noted previously, the primary polymer forms the bulk of the oxygen impermeable composition. The primary polymer may thus be present in the oxygen impermeable composition in an amount of at least about 20 weight percent, based on the weight of the composition (“boc”), and more preferably in an amount of at least about 50 weight percent boc, such as an amount of at least about 75 weight percent boc. Most preferably, the primary polymer is present in the oxygen impermeable composition in an amount of about 100 weight percent, boc. Advantageously, the oxygen impermeable composition includes propylene/ethylene copolymer in an amount of from about 50 to 100 weight percent, boc. In preferred embodiments, the oxygen impermeable composition includes propylene/ethylene copolymer in an amount of about 100 weight percent, boc.

In preferred embodiments of the invention, the microporous layer is formed during extrusion by chemical foaming. In chemical foaming, a blowing agent is added to the polymer composition fed to the extruder. The blowing agent subsequently forms a gas within the molten polymer during extrusion. The gas formed from the blowing agent, typically an inert gas such as CO₂, diffuses out of the extruded film over time. Consequently, in advantageous embodiments of the invention, the oxygen impermeable composition fed to the extruder further includes at least one blowing agent, also commonly referred to as a foaming agent.

The blowing agent employed is not specifically limited so long as it can be adequately dispersed within the oxygen impermeable composition and further provides diffusion properties congruent with those of the multilayer film. A more uniform dispersion of the blowing agent produces a more uniform microporous structure. The blowing agent should thus further be at least partially miscible in the oxygen impermeable composition at the temperature and pressure conditions within the extruder such that at least a portion of the blowing agent dissolves in the molten polymer. Acceptable gas diffusion properties promotes cell stability. Blowing agent miscibility affects cell formation.

In particular, the extruder pushes the melt mixture (melted polymer composition and blowing agent) through a die at the end of the extruder and into a region of reduced temperature and pressure (relative to the temperature and pressure within the extruder). Typically, the region of reduced temperature and pressure is the ambient atmosphere. The sudden reduction in pressure causes that portion of the blowing agent dissolved in the polymer composition to come out of solution, nucleate and vaporize/expand into a plurality of cells within the polymer. The cells solidify upon cooling of the polymer mass (due to the reduction in temperature), thereby trapping the blowing agent within the cells. Following the extrusion and cooling of the multilayer film, a concentration gradient is established between the cells of the microporous layer and the ambient atmosphere, such that the blowing agent will diffuse out of the cells over time while air simultaneously diffuses into the cells. The diffusion properties provided by the multilayered film and the vaporized blowing agent are preferably matched such that an even exchange is made between the egressing vaporized blowing agent and ingressing air, otherwise the foam cell walls may partially or completely collapse, reducing the volume of the resulting nonporous layer.

Any chemical blowing agent known in the art to produce cells within the given primary polymer family may be used. As used herein, the term “chemical blowing agents” include both chemical and physical blowing agents. Exemplary blowing agents for use in conjunction with polypropylene homopolymer or propylene/alpha olefin copolymers include sodium salts of carbonic and polycarboxylic acids; chlorofluorocarbons (such as 1,2-dichlorotetrafluoroethane, dichlorodifluoromethane, trichloromonofluoromethane, etc.); various blends containing isobutene; water; carbon dioxide; air; any inert gas and mixtures thereof. Suitable isobutane blends are described in U.S. Pat. Nos. 6,323,245; 4,694,027; 4,640,933 and 4,663,361. In advantageous embodiments, the blowing agent is sodium salts of carbonic and polycarboxylic acids with polyethylene carrier resins, commercially available as SAFOAM™ FPE-50 from Reedy International Corporation of Keyport, N.J.

The blowing agent is typically included in the oxygen impermeable composition in amounts ranging from about 0.25 to 2.0 weight percent, such as from about 0.3 to 1.5 weight percent, and preferably from about 0.5 to 1.0 weight percent, based the weight of the oxygen impermeable composition.

A foaming accelerator or foaming aid may be included with the blowing agent to lower the volatilization temperature, as known in the art. Conversely, a foaming inhibitor may be incorporated with the blowing agent to raise the volatilization temperature, as further known in the art.

Surprisingly, Applicants have found that microporous layers formed from oxygen impermeable compositions provide multilayer films exhibiting a superior balance of advantageous gas transmission properties and physical properties, e.g., tear propagation properties, than has heretofore been known. Applicants have found that an effective amount of pores, particularly micropores, may be included within the microporous layer to provide a passageway for gas transmission while retaining adequate physical properties within the resulting multilayered film.

Although again not wishing to be bound by theory, Applicants hypothesize that a given pore 13 typically passes through the entire thickness of the microporous layer, as illustrated in FIG. 1. Applicants further hypothesize that a significant portion, e.g. a majority, of the pore ends are “capped” by the heat sealable composition forming at least one of the first and second outer layers 14, 16, as further illustrated in FIG. 1.

In addition to blowing agents, the oxygen impermeable composition may include any particulate filler or other additive known in the art, each present in effective amounts. In particularly advantageous embodiments, the oxygen impermeable composition does not contain particulate filler, such as an inorganic particulate filler, i.e. the oxygen impermeable polymer composition is unfilled.

Returning now to FIG. 1, the first and second outer layers 14 and 16, which are both nonporous, are formed from heat sealable compositions, i.e., the first and second outer layers 14 and 16, are formed from a polymer composition suitable for bonding via the application of heat or radiation. The heat sealable compositions used to form the first and second outer layers 14 and 16 may be the same or may differ. In particularly advantageous embodiments, the first and second outer layers 14 and 16 are formed from the same heat sealable composition. The first and second outer layers 14 and 16 are preferably formed from heat sealable compositions that typically have a melting point of at least about 5° C. lower than the melting point of the oxygen impermeable composition. Advantageously, the first and second outer layers 14 and 16 are formed from heat sealable compositions having a melting point of at least about 10° C. lower than the melting point of the oxygen impermeable composition. The melting points of the heat sealable compositions used to form the first and second outer layers 14 and 16 can independently range up to about 150° C., such as melting points of from about 65° C. to 150° C., particularly melting points of up to about 120° C., and more particularly of up to 100° C.

In particularly advantageous embodiments, the heat sealable compositions are further oxygen permeable. As used herein, oxygen permeable compositions are defined as nonporous compositions having an OTR of at least about 400 cc-mil/100 in²-24 hr.-atm at std. temp., such as an OTR of at least about 500 cc-mil/100 in²-24 hr.-atm at std. temp. In such advantageous embodiments, the OTR of the heat sealable composition should be higher than the OTR of the oxygen impermeable composition. Nonporous films formed from the heat sealable composition may advantageously exhibit an OTR that is at least about 50 cc-mil/100 in²-24 hr-atm@ std. temp. greater than the OTR of comparable nonporous films formed from the oxygen impermeable composition, for example, such as an OTR that is at least about 100 cc-mil/100 in²-24 hr-atm@ std. temp. greater than the OTR of comparable nonporous films formed from the oxygen impermeable composition Suitable primary polymers for use in the heat sealable composition include any heat sealant (or otherwise bondable) polymer known in the art. Non-limiting exemplary primary polymers for use in the heat sealable composition include polyolefins, ethylene vinyl acetate, ethylene methyl acrylate, ethylene butyl acrylate, ethylene methyl acrylic acid, and ionomer. Exemplary polyolefins include very low density polyethylene, linear low density polyethylene, and metallocene polyethylene. Advantageously, the polyolefin is an ethylene/alpha-olefin copolymer, particularly homogeneous ethylene alpha-olefin copolymer, and preferably linear low density polyethylene. Suitable ethylene/alpha-olefin copolymers generally include polymers prepared by the copolymerization of ethylene and any one or more alpha-olefin. Advantageously, the alpha-olefin is a C₃-C₂₀ alpha-monoolefin, such as a C₄-C₁₂ alpha-monoolefin, more preferably a C₄-C₈ alpha-monoolefin. Exemplary alpha-olefins thus include butene-1, hexene-1, and octene-1. In advantageous embodiments, the alpha-olefin comprises octene-1, and/or a blend of hexene-1 and butene-1. In general, the ethylene/alpha-olefin copolymer comprises a copolymer resulting from the copolymerization of from about 80 to 99 weight percent ethylene and from 1 to 20 weight percent alpha-olefin. In advantageous embodiments, the ethylene/alpha-olefin copolymer is linear low density polyethylene, particularly metallocene catalyzed linear low density polyethylene (“LLDPE”). An exemplary LLDPE suitable for use in the invention is DOWLEX™ resin, commercially available from Dow Chemical Company of Midlands, Mich.

The heat sealable composition can advantageously be formed entirely from blends or mixtures including one or more primary polymers, e.g., homogeneous ethylene/alpha-olefin copolymer (or copolymers). For example, in embodiments directed to heat sealable compositions formed from LLDPE, the LLDPE may be blended with effective amounts of other “primary” polymers, such as ethylene vinyl acetate and linear medium density polyethylene. In alternative embodiments, additional polymers may be blended with the primary polymer, as well.

Preferably, the heat sealable composition used in each of the outer layers 14, 16 includes the primary polymer, e.g., homogeneous ethylene/alpha-olefin, in an amount of at least about 20 weight percent, boc. More preferably, the primary polymer is present in the heat sealable composition in an amount of at least about 40 weight percent, such as an amount of about 50 weight percent, and advantageously about 75 weight percent, boc. Most preferably, the primary polymer is present in the heat sealable composition in an amount of about 100 weight percent, boc.

In addition, the heat sealable composition used to form one or both of the outer layers 14, 16 may further contain non-polymeric additives in amounts known in the art. For example, the heat sealable composition used to form one or both of the outer layers 14, 16 may contain slip and/or antiblock agents, as known in the art. Non-limiting exemplary slip agents include silica, amide wax, and mixtures thereof. Non-limiting exemplary antiblock agents include diatomaceous earth, calcium carbonate and mixtures thereof. Pre-blended slip/antiblock concentrates, commonly referred to as masterbatches, are commercially available, such as FSU93E™ from A. Shulman of Akron, Ohio.

The slip and antiblock agents may be included within the heat sealable composition in effective amounts known to those skilled in the art. For example, the slip and antiblock agents may independently be present within the heat sealable composition in amounts of about 2 to 8 weight percent, such as in amounts of about 4 weight percent.

One or more antifog agents may further be included in the heat sealable composition used to form one or more of the outer layers 14, 16. Exemplary types and amounts of antifog agents suitable for use in the invention are provided in U.S. Pat. No. 5,962,092 to Kuo et al, which is incorporated herein by reference. Exemplary antifogging agents include aliphatic alcohol, polyether, polyhydric alcohol, ester of polyhydric alcohol, polyethoxylated aromatic alcohol and mixtures thereof.

Further additives which may be included within the heat sealable compositions include antioxidants, fillers, dyes, pigments and dyes, radiation stabilizers, antistatic agents, elastomers, and the like additives known to those of skill in the art of packaging films.

The “three” layer construction illustrated in FIG. 1, with a microporous center layer and heat scalable outer layers, may further include layers (not shown in FIG. 1) that promote adhesion between the various layers as required, i.e., tie layers. Such tie layers would be disposed between the center microporous layer and the heat sealable outer layers. The tie layers may be formed from compositions known in the art to promote adhesion between the given primary polymers within the various layers. For example, tie layers formed from maleic anhydride grafted polyolefins, such as BYNEL® from DuPont or PLEXAR® from Equistar may be employed for embodiments in which the oxygen impermeable composition is formed from polyester and the heat sealable composition is formed from LLDPE. When required to achieve acceptable adhesion, the tie layers need be only thick enough to effectuate the desired tying function. Advantageously, the tie layer or layers each has a thickness of from about 0.05 to 0.5 mil, such as a thickness of from about 0.1 to 0.3 mil.

At least one of the outer layers 14, 16 may also be surface treated to increase its surface energy, as known in the art. The treated outer layer may then further be printed. For example, at least one of the outer layers 14, 16 may be electrostatically treated, e.g., corona treated, to a surface tension of greater than about 38 dynes/cm, such as from about 42 to 46 dynes/cm, and subsequently printed. Preferably the printing will adhere to the printed outer layer to a level of at least about 80% as measured by a standard tape test.

Typically, the two outer layers 14, 16 each make up from about 10 to 80 volume percent of the total volume of the multilayer film 10. The microporous layer 12 can also make up from about 10 to 80 volume percent of the total volume of the multilayer film 10. Advantageously, the two outer layers 14, 16 each make up from about 10 to 40 volume percent of the total volume of the multilayer film 10, and the microporous layer 12 makes up from about 20 to 80 volume percent of the total volume of the multilayer film 10.

Typically, the microporous layer 12 is at least as thick as each of the outer layers 14, 16, and advantageously the microporous layer 12 is thicker than either of the outer layers 14, 16. The outer layers 14, 16 each typically have a thickness ranging from about 0.05 to 4 mils. Advantageously, each of the outer layers 14, 16 has a thickness of from about 0.1 mil to 2 mils, such as a thickness of from about 0.1 mil to 1.2 mils, still more particularly, from about 0.3 mil to 0.8 mil. The microporous layer 12 typically has a thickness of from about 0.1 mil to 8 mils, advantageously, from about 0.2 mil to 4 mils, and more particularly, from about 0.2 mil to 2.4 mils.

As depicted in FIG. 1, the multilayered films of the invention generally comprise at least 3 layers. In alternative embodiments, the multilayered films may comprise any number of layers, such as a 2 to 7 layer film, and more particularly a 4 to 6 layer film. Aspects of the invention directed to two layers include a microporous layer formed from an oxygen impermeable composition in combination with a single nonporous layer formed from a heat sealable composition. Exemplary heat sealable and oxygen impermeable compositions and various additives suitable for use in the two layered embodiment are the same as those described above for use in the three layered embodiment. The two layered embodiment would further generally employ the beneficial layer volume ratios noted for use in the three layered embodiment described above.

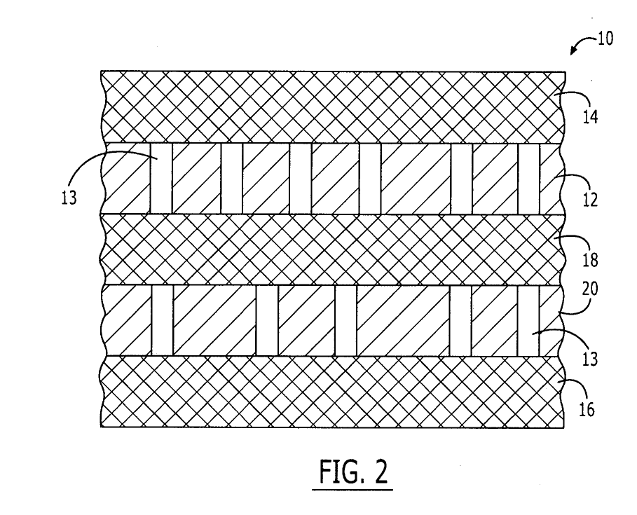

FIG. 2 illustrates a cross-sectional view of an advantageous five layer embodiment of the multilayer film 10 of the invention. The five layer embodiment of FIG. 2 includes a nonporous center layer 18 disposed between two microporous layers 12 and 20. The two microporous layers 12 and 20 are, in turn, disposed between outer layers 14, 16.

In advantageous embodiments the nonporous center layer 18 is formed from a heat sealable composition. As in the three layered embodiment, the first and second outer layers 14 and 16, which are also both nonporous, are also formed from heat sealable compositions. The microporous layers 12 and 20 are formed from oxygen impermeable compositions.

Applicants have found that interior nonporous layers, e.g., a centermost nonporous layer, in conjunction with multiple microporous layers provides greater uniformity in multilayered films formed by coextrusion in which the outer layers are further formed from low density materials. More particularly, Applicants have found that nonporous spacer layers along with multiple microporous layers decreases the formation of holes within the outer layers 14, 16 during film formation. Although not wishing to be bound by theory, Applicants hypothesize that interior nonporous layers, e.g., the centermost nonporous layer 18, provides a protective spacer between the microporous layers 12, 20 during pore formation.

As noted above, the microporous layers within the coextruded multilayered films of the invention are preferably chemically foamed. Applicants hypothesize that excessive quantities of blowing agent, such as pockets of poorly dispersed blowing agent, may generate sufficient vapor pressure to actually break through the outer layers, rather than diffusing out, yielding pin holes within the outer layer 14, 16. Applicants have found that a centermost nonporous layer yields fewer breakthroughs within the outer layers. Applicants further hypothesize that the use of a centermost nonporous layer allows thinner microporous layers to be employed. The presence of the centermost nonporous layer 18 may thus ensure that pockets of vaporized foaming agent large enough to break through the outer layers 14, 16 do not develop within the thinner microporous layers 12, 20 during pore formation.

Exemplary heat sealable compositions and various additives suitable for use in the five layered embodiment of FIG. 2 are the same as those described above for use in the three layered embodiment. The center layer 18, first outer layer 14 and second outer layer 16 may each be formed from the same or different heat sealable compositions. In advantageous embodiments, the center layer 18, first outer layer 14 and second outer layer 16 are formed from the same heat sealable composition. In beneficial aspects of such advantageous embodiments, the heat sealable composition is formed from linear low density polyethylene, particularly metallocene catalyzed linear low density polyethylene. Advantageously, the first and second outer layers 14, 16 further include non-polymeric additives, such as the slip and/or antiblock agents described above. The slip and/or antiblock agents may be included in the first and second outer layers 14, 16 in amounts known in the art, such as an amount of about 4 weight percent.

Exemplary oxygen impermeable compositions and various additives suitable for use in the five layered embodiment illustrated in FIG. 2 are the same as those described above for use in the three layered embodiment. The microporous layers 12 and 20 may each be formed from the same or different oxygen impermeable composition. In advantageous embodiments, the microporous layers 12 and 20 are formed from the same oxygen impermeable composition. In beneficial aspects of such advantageous embodiments, the oxygen impermeable composition is formed from propylene-ethylene copolymer, particularly propylene-ethylene random copolymer. In beneficial aspects of such embodiments, the propylene/ethylene copolymer contains from about 0.1 to 6 weight percent ethylene, such as from about 2 to 5 weight percent ethylene, particularly about 4 weight percent ethylene.

The “five” layer construction illustrated in FIG. 2 may further include layers (not shown in FIG. 2) that promote adhesion between the various layers, i.e., tie layers. Such tie layers could be disposed between the center layer, microporous layers and the oxygen permeable outer layers. The tie layers may be formed from compositions known in the art to promote adhesion between the given primary polymers within the various layers. For example, tie layers formed from maleic anhydride grafted polyolefins, such as BYNEL® from DuPont or PLEXAR® from Equistar may be employed for embodiments in which the oxygen impermeable composition is formed from polyester and the oxygen permeable composition is formed from LLDPE. When required to achieve acceptable adhesion, the tie layers need be only thick enough to effectuate the desired tying function. Advantageously, the tie layer or layers each has a thickness of from about 0.05 to 0.5 mil, such as a thickness of from about 0.1 to 0.3 mil.

Typically, the two outer layers 14, 16 and the center layer 18 of the five layered embodiments each make up from about 10 to 80 volume percent of the total volume of the multilayer film 10. The microporous layers 12, 20 can also make up from about 10 to 80 volume percent of the total volume of the multilayer film 10. Advantageously, the two outer layers 14, 16 and center layer 18 each make up from about 10 to 40 volume percent of the total volume of the multilayer film 10, and the microporous layers 12, 20 make up from about 20 to 80 volume percent of the total volume of the multilayer film 10.

The microporous layers 12, 20 is typically at least as thick as each of the outer layers 14, 16, and advantageously the microporous layers 12, 20 are thicker than either of the outer layers 14, 16. The two outer layers 14, 16 each typically have a thickness ranging from about 0.05 to 4 mils. Advantageously, each of the outer layers 14, 16 has a thickness of from about 0.1 mil to 2 mils, such as a thickness of from about 0.1 mil to 1.2 mils, still more particularly, from about 0.3 mil to 0.8 mil. The microporous layers 12, 20 typically each have a thickness of from about 0.1 mil to 8 mils, advantageously, from about 0.2 mil to 4 mils, and more particularly, from about 0.2 mil to 2.4 mils.

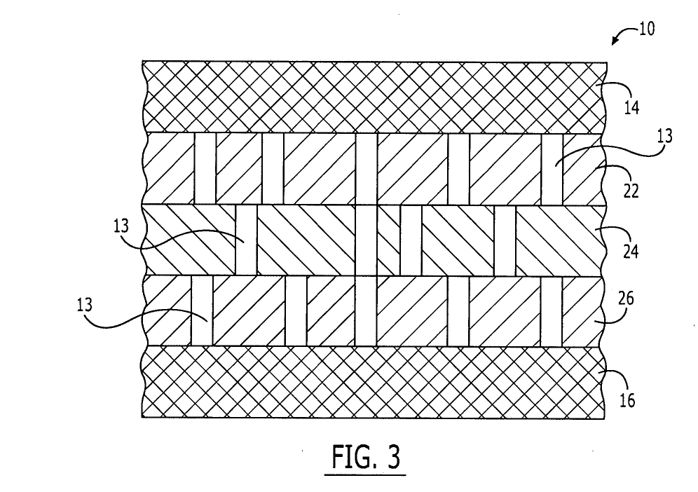

An alternative advantageous five layer embodiment is illustrated in FIG. 3. In such embodiments, three microporous layers 22, 24 and 26 are disposed between nonporous outer layers 14, 16. In such advantageous embodiments, the three microporous layers 22, 24 and 26 are each independently formed from the oxygen impermeable compositions described above. Similarly, the first and second outer layers 14 and 16, which are both nonporous, are each independently formed from the heat sealable compositions described above.

As with the previous embodiments, the two outer layers 14, 16 of the five layered embodiment of FIG. 3 each make up from about 10 to 80 volume percent of the total volume of the multilayer film 10. The three microporous layers 22, 24 and 26, can also make up from about 10 to 80 volume percent of the total volume of the multilayer film 10. Advantageously, the two outer layers 14, 16 each make up from about 10 to 40 volume percent of the total volume of the multilayer film 10, and the three microporous layers 22, 24, 26 make up from about 20 to 80 volume percent of the total volume of the multilayer film 10.

The microporous layers 22, 24, 26 are typically at least as thick as each of the outer layers 14, 16, and advantageously the microporous layers 22, 24, 26 are thicker than either of the outer layers 14, 16. The outer layers each typically have a thickness ranging from about 0.05 to 4 mils. Advantageously, each of the outer layers 14, 16 has a thickness of from about 0.1 mil to 2 mils, such as a thickness of from about 0.1 mil to 1.2 mils, still more particularly, from about 0.3 mil to 0.8 mil. The three microporous layers 22, 24, 26 typically each have a thickness of from about 0.1 mil to 8 mils, advantageously, from about 0.2 mil to 4 mils, and more particularly, from about 0.2 mil to 2.4 mils.

Regardless of the number of layers employed, the multilayer film 10 can have any total thickness which provides an acceptable level of physical properties, e.g., a desired rate of oxygen, carbon dioxide and water vapor transmission, abuse resistance, physical properties, and the like. Advantageously, the multilayer film has a total thickness (i.e., a combined thickness of all layers), of from about 0.5 to 10 mils; more advantageously, from about 1 to 5 mils; still more advantageously, from 1 to 3 mils. Preferably, the multilayer film 10 has a thickness of from about 1.5 to 2.5 mils.

The multilayer films of the invention typically exhibit an O₂-transmission rate of from about 160 to 1290 cc/100 in²-24 hr-atm@std.temp., preferably, from about 250 to 650 cc/100 in²-24 hr-atm@std.temp. The multilayer films of the invention generally exhibit a CO₂-transmission rate of from about 500 to 5200 cc/100 in²-24 hr-atm@std.temp., preferably, from about 1000 to 2650 cc/100 in²-24 hr-atm@std.temp.

The multilayer films of the invention further provide surprisingly beneficial bending stiffness properties. For a multilayer film made of materials that exhibit differing modulus, the bending stiffness is a complex function of each layer's modulus, thickness and location. Although again not wishing to be bound by theory, Applicants hypothesize that the beneficial bending stiffness properties of the invention result from the increased film thickness provided by the microporous layer in comparison to comparable multilayer films formed from the same amount of material without such microporous layers. This increased film thickness translates into a greater distance between the neutral axis and the outermost surface of the film, resulting in an increased bending stiffness.

The polymers and polymer compositions in accordance with the invention are formed in accordance with methods well known in the art. For example, the olefinic polymers and copolymers which may be employed within the heat sealable and oxygen impermeable compositions may be formed by the addition polymerization of the monomers or comonomers in the presence of a catalyst, such as Ziegler catalyst or metallocene catalyst, as well known in the art.

The heat sealable and oxygen impermeable compositions to be used in the invention typically have a MFR of from about 0.1 to 30 g/10 min, preferably from about 2 to 15 g/10 min.

Conventional blending and/or compounding techniques may be used as required to incorporate the various primary polymers, optional components and/or blowing agents to form the heat sealable and oxygen impermeable compositions, respectively.

Multilayer films in accordance with the present invention can be manufactured using film fabrication technologies well-known in the art. For example, the base film may be extruded into a film using a flat die, or extruded into a film using an annular die, and the outer layers formed thereon by solvent deposition, lamination or coextrusion techniques. However, the preferred method of manufacture of the multilayer film of the invention is via simultaneous coextrusion, in an annular die, of all the layers of the multilayer film.

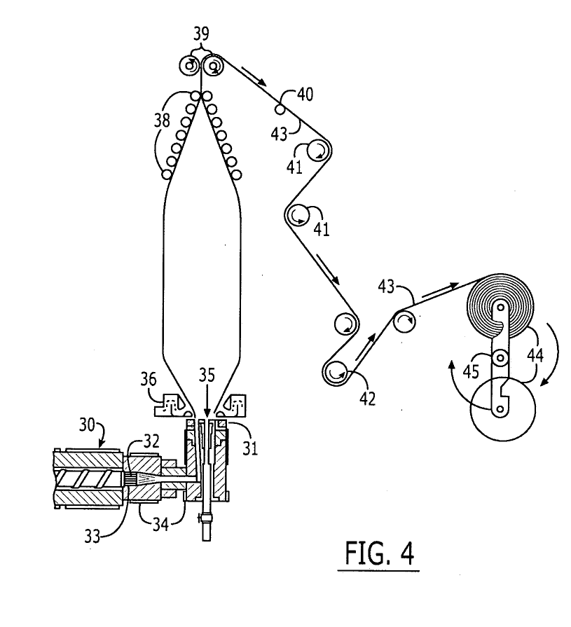

FIG. 4 illustrates a schematic view of a process according to the present invention, for producing a multilayer film in accordance with the present invention. Although for the sake of simplicity only one extruder 30 is illustrated in FIG. 4, there are preferably at least two extruders, and more preferably, at least three extruders. That is, preferably at least one extruder, and more preferably two extruders, supply molten polymer to coextrusion die 31 for the formation of, for example, outer layers 14 and 16 as illustrated in FIG. 1, and at least one additional extruder supplied molten polymer to coextrusion die 31 for the formation of, for example, the microporous layer 12 as illustrated in FIG. 1. Each of the extruders is supplied with polymer pellets suitable for the formation of the respective layer it is extruding. The extruders subject the polymer pellets to sufficient pressure and heat to melt the polymer and thereby prepare it for extrusion through a die.

Taking extruder 30 as an example, each of the extruders is preferably equipped with a screen pack 32, a breaker plate 33, and a plurality of heaters 34. Each of the coextruded film layers is extruded between mandrel 35 and die 31, and the extrudate is cooled by cool air flowing from air ring 36. The resulting blown bubble is thereafter guided into a collapsed configuration by nip rolls 39, via guide rolls 38. The collapsed tube is optionally passed over treater bar 40, and is thereafter passed over idler rolls 41, and around dancer roll 42 which imparts tension control to collapsed tube 43, after which the collapsed tube is wound into roll 44 via winding mechanism 45.

The process according to the present invention can, in general, be carried out the manner illustrated in FIG. 4. Preferably the process is carried out in a manner to result in the preferred multilayer film according to the present invention as described above. In order to extrude a first composition comprising a heat sealable composition to form the first layer, and extrude a second composition comprising the oxygen impermeable composition to form the second layer, and extrude a third composition comprising a heat sealable composition to form the third layer, it is necessary to carry out the process by selecting and proportioning each of these three chemical compositions in an manner to result in a multilayer film having a second layer between the first and third layers, and to provide the multilayer film with an O₂-transmission rate of from about 160 to 1290 cc/100 in²-24 hr-atm@std.temp. The details of selecting and proportioning are readily evident to those of skill in the art in view of the above detailed description of the multilayer film of the present invention. Preferably, the process is carried out to result in a preferred film according to the present invention.

Although the multilayer film of the present invention is preferably not electronically cross-linked, optionally the film may be electronically cross-linked. In the process, the film is subjected to a high energy electron treatment, which induces cross-linking between molecules of the treated material.

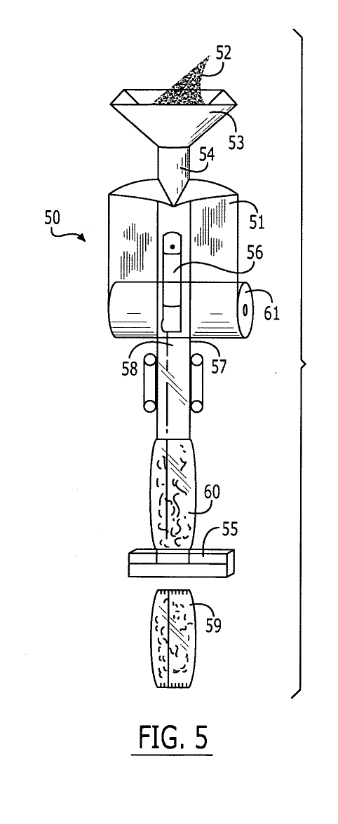

FIG. 5 illustrates a vertical form fill and seal apparatus to be used in packaging process according to the present invention. Vertical form fill and seal equipment is well known to those of skill in the packaging arts. As illustrated in FIG. 5, apparatus 50 utilizes multilayer film 51 according to the present invention. Product 52, to be packaged, is supplied to apparatus 50 from a source (not illustrated), from which a predetermined quantity of product 52 reaches upper end portion of forming tube 54 via funnel 53, or other conventional means. The packages are formed in a lower portion of apparatus 50, and flexible sheet material 51 from which the bags or packages are formed is fed from roll 61 over certain forming bars (not illustrated), is wrapped about forming tube 54, and is provided with longitudinal seal 57 by longitudinal heat sealing device 56, resulting in the formation of vertically-oriented tube 58. End seal bars 55 operate to close and seal horizontally across the lower end of vertically-sealed tube 58, to form pouch 60 which is thereafter immediately packed with product 52. Film drive belts 62, powered and directed by rollers, as illustrated, advance tube 58 and pouch 60 a predetermined distance, after which end seal bars 55 close and simultaneously seal horizontally across the lower end of vertically-sealed tube 58 as well as simultaneously sealing horizontally across upper end of sealed pouch 59, to form a product packaged in sealed pouch 59. The next pouch 60, thereabove, is then filled with a metered quantity of product 52, forwarded, and so on. It is also conventional to incorporate with the end seal bars a cut-off knife (not shown) which operates to sever a lower sealed pouch 59 from the bottom of upstream pouch 60.

In carrying out the packaging process of the present invention, preferably the vertical form fill and seal machine forms, fills, and seals at least 10 packages per minute, preferably from about 15 to 45 packages per minute and in some machines as high as 60 packages per minute, without substantial burn through of the film at the seals.

Although the packaging process may be carried out with any film according to the present invention, the packaging process is preferably carried out using a preferred film according to the present invention. Preferably, the film is sealed at the lowest possible temperature at which relatively strong seals are produced.

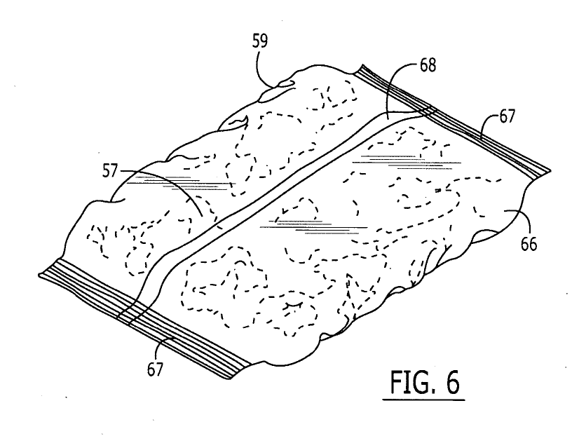

FIG. 6 illustrates one embodiment of a packaged product 59 of the present invention, the product being packaged in sealed pouch 66 having end seals 67 and a vertical seal 68. Package 66 is a multilayer film of the present invention as produced in a vertical form fill and seal apparatus, in accordance with the packaging process of the present invention as described above. If the package is printed, the printing is on the outer surface of the other outer film layer, which forms the outside layer of the package. In alternative embodiments, multilayer films of the invention may be used as lidding stock. Lidding stock is generally defined as a covering material used over trays or as a top web in thermoformed packaging.

In general, the product in the package can be any oxygen-sensitive product, e.g., a foodstuff, such as any meat, dairy product, fruit or cut vegetable.

The invention is illustrated by the following examples, which are provided for the purpose of representation, and are not to be construed as limiting the scope of the invention. Unless stated otherwise, all percentages, parts, etc. are by weight.

### EXAMPLES 1-3

A series of coextruded, multilayer films were produced on conventional hot blown film equipment equipped with a multilayer annular die, to produce films having an A/B/C/B/A-type structure. The films had average thicknesses before foaming of from 1.25 to 1.8 mils. For each film, the two outer layers A and the center layer C were each composed of metallocene catalyzed LDPE (mLDPE) having a density of about 0.902 gm/cc, and a melt index of about 3.0 gm/10 min (using Condition E of ASTM D-1238), commercially available as AFFINITY PL 1850 from Dow Chemical Company of Midlands, Mich. For each of the outer film layers A, the mLLDPE was preblended with 4 weight percent FSU™ 93E® slip/antiblock concentrate, obtained from A. Schulman of Akron, Ohio, to allow easy separation of the film plies at the winder, and for good machinability on the VFFS packaging equipment.

The microporous layers, the B-layer, was composed of propylene/ethylene copolymer (“PEC”). The propylene/ethylene copolymer in the B-layer contained about 4.0 weight percent ethylene, and had a density of about 0.900 g/cc and a melt flow rate of about 4.0 g/10 min. (Condition L of ASTM D-1238) and is commercially available as 6D65L from Dow Chemical Company of Midlands, Mich. The propylene/ethylene copolymer in the B-layer was preblended with 1 weight percent SAFOAM FPE-50™ blowing agent commercially available from Reedy International Corporation of Keyport, N.J.

The polymer formulations for the A-layers, B-layers, and C layer were fed into the hoppers of extruders which feed the coextrusion die. The materials were coextruded through an annular coextrusion die, exited the die, and were blown to a desired width while simultaneously being cooled with an air ring. The cooled film was then collapsed, ply separated, and wound on cores for further processing.

The resulting exemplary film thicknesses and OTR values for each of Examples 1 through 3 are given in Table 1 below.

TABLE 1

| | | | Film | |
|---|---|---|---|---|
| | | Unfoamed | Thickness | |
| | | Film | After | OTR (cc/100 in²- |
| | Layer Ratios | Thickness | Foaming | 24 hr- |
| Example | (vol. ratios) | (mil) | (mil) | atm@std.temp.) |
| 1 | 25/25/25/25/25 | 1.25 | 1.6 | 409.6 |
| 2 | 30/25/30/25/30 | 1.40 | 2.5 | 326.3 |
| 3 | 40/30/40/30/40 | 1.8 | 2.2 | 308.9 |

As indicated in Table 1, the five layer films of the invention generally exhibit OTR values of about 300 cc/100 in²-24 hr-atm@std.temp. or greater. In contrast, comparable five layered non-foamed films, i.e. films which do not contain the advantageous microporous layers of the invention, would be expected to exhibit an OTR of less than about 300 cc/100 in²-24 hr-atm@std.temp. Consequently, the microporous layers within the films of the invention provide a beneficial increase in OTR.

### EXAMPLES 4-11

A further series of coextruded, multilayer films having an A/B/A-type structure were produced using the methods described in Examples 1-3. The nominal thickness for each of Examples 4 through 11 prior to foaming was about 1.4 mil. The materials and resulting properties for each of Examples 4 through 11 are given in Table 2 below.

TABLE 2

| | | | | Avg. OTR |
|---|---|---|---|---|
| | | Layer Ratios | Avg. Film | (cc/100 in²-24 hr- |
| Example | Structure | (vol. ratios) | Thickness (mil) | atm@std.temp.) |
| 4 | A₁/B₁/A₁ | 4/2/4 | 1.86 | 519 |
| 5 | A₁/B₁/A₁ | 3.5/3/3.5 | 2.42 | 429 |
| 6 | A₁/B₁/A₁ | 3/4/3 | 2.68 | 577 |
| 7 | A₁/B₁/A₁ | 1/2/1 | 3.19 | 287 |
| 8 | A₂/B₁/A₂ | 4/2/4 | 1.79 | 319 |
| 9 | A₂/B₁/A₂ | 3.5/3/3.5 | 1.88 | 335 |
| 10 | A₂/B₁/A₂ | 3/4/3 | 2.27 | 474 |
| 11 | A₂/B₁/A₂ | 1/2/1 | 2.02 | 316 |

Where:
A₁ = 97% DOWLEX ™ 2247G LLDPE (0.917 Density, 2.3 Melt Index) + 3% A Schulman FSU ™ 93E Slip & Antiblock Masterbatch
A₂ = 97% DOWLEX ™ 2045.04 LLDPE (0.920 Density, 1.0 Melt Index) + 3% A Schulman FSU ™ 93E Slip & Antiblock Masterbatch
B₁ = 99% Exxon ESCORENE ™ PP-4062.E7 Polypropylene (0.9 Density, 3.5 Melt Flow) + 1% SAFOAM ™ FPE-50 Foaming Agent

As indicated in Table 2, the three layered films of the invention generally exhibit OTR values that are about 280 cc/100 in²-24 hr.-atm @ std. temp. or higher, confirming the results provided in Table 1. Such beneficial OTR values are substantially higher than would be expected for comparable film constructions lacking the microporous layer of the invention.

### EXAMPLES 12-14 AND COMPARATIVE EXAMPLES 1-6

A series of coextruded, multilayer films having an A/B/A-type structure were produced using the methods described in Examples 1-3. The materials and resulting properties for each of Examples 12-14 and Comparative Examples 1-6 are given in Table 3 below.

TABLE 3

| | Sample I.D. | | | | | | | | |
|---|---|---|---|---|---|---|---|---|---|
| | CEx 1 | Ex 12 | Cex 2 | CEx 3 | Ex 13 | CEx 4 | CEx 5 | Ex 14 | CEx 6 |
| No. of Layers | 3 | 3 | 3 | 3 | 3 | 3 | 3 | 3 | 3 |
| Film Structure | A₁/B₁/A₁ | A₁/B₂/A₁ | A₁/B₁/₁ | A₂/B₁/A₂ | A₂/B₂/A₂ | A₂/B₁/A₂ | A₂/B₁/A₂ | A₂/B₂/A₂ | A₂/B₁/A₂ |
| Layer Ratio (vol. ratios) | 40/20/40 | 40/20/40 | 40/20/40 | 40/20/40 | 40/20/40 | 40/20/40 | 35/30/35 | 35/30/35 | 35/30/35 |
| Film Thickness, (mil) | 1.47 | 2.3 | 2.32 | 1.43 | 1.77 | 1.95 | 1.41 | 2.11 | 2.13 |
| Elongation at break | | | | | | | | | |
| (%) MD | 760 | 480 | 800 | 670 | 490 | 700 | 680 | 480 | 710 |
| TD | 850 | 290 | 840 | 790 | 560 | 800 | 800 | 280 | 820 |
| Tear Propa-gation, | | | | | | | | | |
| [Energy to Break Point] | | | | | | | | | |
| (gm.-in.) | | | | | | | | | |
| MD | 488 | 707 | 972 | 462 | 826 | 742 | 420 | 612 | 759 |
| TD | 1,057 | 1,030 | 1,473 | 1,474 | 1,118 | 1,596 | 1,716 | 996 | 1,546 |
| Tear Resistance, | | | | | | | | | |
| [Energy to Break Point] | | | | | | | | | |
| (gm.-in.) | | | | | | | | | |
| MD | 530 | 686 | 872 | 429 | 627 | 676 | 433 | 709 | 658 |
| TD | 612 | 758 | 1,026 | 664 | 687 | 859 | 726 | 750 | 929 |
| Instrumented Impact | 0.14 | 0.13 | 0.24 | 0.15 | 0.15 | 0.21 | 0.16 | 0.15 | 0.22 |
| [Energy to Break] | | | | | | | | | |
| (ft.-lb.) | | | | | | | | | |
| OTR @ 73° F. (cc/100 | 256 | 349 | 151 | 240 | 284 | 175 | 227 | 330 | 150 |
| sq.in.-24 hrs-atm) @ | | | | | | | | | |
| 0% RH | | | | | | | | | |
| MVTR @ 100° F. | 0.69 | 0.85 | 0.41 | 0.66 | 0.71 | 0.46 | 0.61 | 0.81 | 0.38 |
| (gm/100 sq.in.-24 hrs- | | | | | | | | | |
| atm @ 90% RH | | | | | | | | | |

Where:
A₁ = 97% DOWLEX ™ 2247G LLDPE (0.917 Density, 2.3 Melt Index) + 3% A Schulman FSU ™ 93E Slip & Antiblock Masterbatch
A₂ = 97% DOWLEX ™ 2045.04 LLDPE (0.920 Density, 1.0 Melt Index) + 3% A Schulman FSU ™ 93E Slip & Antiblock Masterbatch
B₁ = 99% Exxon ESCORENE ™ PP-4062.E7 Polypropylene (0.9 Density, 3.6 Melt Flow)
B₂ = 99% Exxon ESCORENE ™ PP-4062.E7 Polypropylene (0.9 Density, 3.6 Melt Flow) + 1% SAFOAM ™ FPE-50 Foaming Agent

As indicated in Table 3, the three layer films of the invention exhibit OTR values that are substantially higher than comparable multilayer films that lack nonporous layers. More specifically, films formed in accordance with the invention generally exhibit OTR values of greater than about 280 cc/100 in²-24 hr.-atm @ std. temp. or higher. In contrast, comparable non-foamed films, i.e. films which do not contain the advantageous microporous layers of the invention, exhibit an OTR of about 260 cc/100 in²-24 hr-atm@std.temp. or less.

Surprisingly, the films of the invention further provide improved tear propagation properties and lower elongation at break in comparison to comparable films without microporous films. Such improved tear propagation translates into more robust packaging films, i.e. packaging films that better withstand the stresses induced during shipment and the like. The films of the invention further unexpectedly provide very short or non-existant plastic regions after yield. The smaller plastic regions and lower elongations at break of the films of the invention promotes consistent bag length during the packaging process. Hence the microporous layers of the films of the invention may be used to inexpensively increase the OTR and robustness of the resulting multilayer film. Additionally, the microporous layers of the films of the invention do not significantly detrimentally affect the impact properties, as indicated in Table 3.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A multilayer film comprising:
a first outer layer;
a second outer layer; and
at least one intermediate microporous layer disposed between said first and second outer layers,
said first and second outer layers independently formed from heat sealable compositions and said intermediate layer formed from an oxygen impermeable composition.

2. A multilayer film according to claim 1, wherein said heat sealable composition exhibits an oxygen transmission rate that is at least about 50 cc-mil/100 in²-24 hr-atm @ std.temp. higher than said oxygen impermeable composition.

3. A multilayer film according to claim 1, wherein said oxygen impermeable composition exhibits a melting point that is at least about 5° C. higher than said heat sealable composition.

4. A multilayer film according to claim 1, wherein said oxygen impermeable composition exhibits a modulus that is at least about 5,000 psi higher than said heat sealable composition.

5. A multilayer film according to claim 1, wherein said oxygen impermeable composition comprises at least one of polyethylene homopolymer, polypropylene homopolymer, ethylene/alpha-olefin copolymer, propylene/alpha-olefin copolymer, ethylene/unsaturated ester copolymer, styrene homopolymer or copolymer, and polyester homopolymer or copolymer as a primary polymer.

6. A multilayer film according to claim 1, wherein said oxygen impermeable composition comprises polypropylene/alpha-olefin copolymer as a primary polymer.

7. A multilayer film according to claim 1, wherein said heat sealable composition comprises at least one of polyolefin, ethylene vinyl acetate, ethylene methyl acrylate, ethylene butyl acrylate, ethylene methyl acid and ionomer as a primary polymer.

8. A multilayer film according to claim 1, wherein said heat sealable composition comprises an ethylene/alpha olefin copolymer as a primary polymer.

9. A multilayer film according to claim 1, wherein said heat sealable composition comprises linear low density polyethylene as a primary polymer.

10. A multilayer film comprising:
a first outer layer;
a second outer layer;
a center layer;
a first intermediate microporous layer disposed between said first outer layer and said center layer; and
a second intermediate microporous layer disposed between said second outer layer and said center layer,
said first and second outer layers and said center layer each independently comprising a heat sealable composition and said first and second intermediate layers each independently comprising an oxygen impermeable composition.

11. A multilayer film according to claim 10, wherein said unfilled oxygen impermeable polymer composition comprises propylene/alpha olefin copolymer as a primary polymer.

12. A multilayer film according to claim 10, wherein said heat sealable composition comprises an ethylene/alpha-olefin copolymer as a primary polymer.

13. A multilayer film according to claim 10, wherein said heat sealable composition comprises linear low density polyethylene as a primary polymer.

14. A package comprising:
(a) an oxygen-sensitive product; and
(b) a mutlilayer film comprising
(i) a first outer layer formed from a heat sealable composition;
(ii) a second outer layer formed from a heat sealable composition; and
(iii) at least one intermediate microporous layer disposed between said first and second outer layers, said intermediate layer formed from an oxygen impermeable composition.

15. A package according to claim 14, wherein said multilayer film substantially surrounds said oxygen-sensitive product.

16. A package according to claim 14, wherein said oxygen-sensitive product comprises at least one foodstuff selected from the group consisting of meat, dairy products, fruits and cut vegetables.

17. A package according to claim 14, wherein said multilayer film is lidding stock.

18. A method of forming a multilayer film, said method comprising
(a) forming a microporous polymer composition by combining an effective amount of at least one blowing agent with an oxygen impermeable composition; and
(b) coextruding at least one microporous layer comprising the microporous polymer composition along with outer nonporous layers comprising heat sealable compositions.

19. A method of forming a multilayer film according to claim 18, wherein said chemical blowing agent comprises at least one member selected from the group consisting of sodium salts of carbonic and polycarboxylic acids, chlorofluorocarbons, isobutene blends, water, carbon dioxide, air and mixtures thereof.

20. A method of forming a multilayer film according to claim 18, wherein said chemical blowing agent comprises sodium salts of carbonic and polycarboxylic acids.

21. A method of forming a multilayer film according to claim 18, wherein an effective amount of at least one chemical blowing agent ranges from about 0.25 to 2 weight percent, based on the weight of the oxygen impermeable composition.

22. A method of forming a multilayer film according to claim 18, further comprising coextruding two microporous layers comprising the microporous polymer composition along with a nonporous center layer comprising a heat sealable composition disposed between the two microporous layers.

23. A method of forming a multilayer film according to claim 18, further comprising coextruding three layers comprising the microporous polymer composition.
